(19) United States
(12) Patent Application Publication
(10) Pub. No.: US 2024/0351655 A1
(43) Pub. Date: Oct. 24, 2024

(54) DISTRIBUTING UNIT FOR AN ELECTRIC BICYCLE

(71) Applicant: ZF Friedrichshafen AG, Friedrichshafen (DE)

(72) Inventor: Jakob Lauhoff, Tübingen (DE)

(73) Assignee: ZF Friedrichshafen AG, Friedrichshafen (DE)

(21) Appl. No.: 18/685,390

(22) PCT Filed: Aug. 25, 2022
(86) PCT No.: PCT/EP2022/073711

§ 371 Date: Feb. 21, 2024

(30) Foreign Application Priority Data
Aug. 27, 2021 (DE) 10 2021 209 424.4

(51) Int. Cl. B62J 43/30; B62J 43/13; B62J 43/28; B62M 6/45; H02J 7/00

(52) U.S. Cl. CPC B62J 43/30; B62J 43/13; B62J 43/28; B62M 6/45; H02J 7/0042; H02J 7/0047

(57) ABSTRACT

A distributor unit (2) for an electric bicycle (4) is shown, where the distributor unit (2) is designed to be arranged in an upper tube (6) of the bicycle (4). The distributor unit (2) includes a control unit (10) and a power-transmitting interface (12). The distributor unit (2) can be power-connected to a battery (14) of the bicycle (4) by way of the power-transmitting interface (12), and the distributor unit (2) can be power-connected to a consumer (16) by way of the power-transmitting interface (12). The control unit (10) is designed to control the supply of electrical energy to the consumer (16) from the battery (14) via the distributor unit (2) in accordance with a control signal. In addition, a bicycle (4) with such a distributor unit (2) is shown.

### RELATED APPLICATIONS

This application claims the benefit under 35 U.S.C. § 371 as a U.S. National Phase application of application no. PCT/EP2022/073711, filed on 25 Aug. 2022, which claims the benefit of German Patent Application no. 10 2021 209 424.4 filed on 27 Aug. 2021, the contents of which are hereby incorporated herein by reference in their entireties.

### TECHNICAL FIELD

The technical field relates to a distributor unit for an electric bicycle, and to an electric bicycle with a distributor unit of that type.

### BACKGROUND

Electric bicycles are known from the prior art, which have additional consumers in addition to a battery and a drive unit, comprising a drive motor and a motor control device. The consumers are supplied with electrical energy from the battery by way of the drive unit by the control and supply system by way of the motor control unit.

### SUMMARY OF THE INVENTION

The invention relates to a distributor unit for an electric bicycle. The distributor unit is designed to be arranged in an upper tube of the bicycle frame. Alternatively, or in addition, the distributor unit can be designed to be accommodated in any other tube of the bicycle frame, for example a seat column or a lower frame tube. The distributor unit can be designed to be arranged in the upper tube of the bicycle during the assembly of the electric bicycle. Alternatively, or in addition, the distributor unit can be designed to be fitted into an upper tube of the bicycle after the bicycle has been assembled. In other words, the distributor unit can be a unit that can be retrofitted.

The distributor unit comprises a control unit and a power-transmitting interface. The control unit can comprise a memory in which execution codes can be stored, so that the control unit can be designed to be operated by means of the execution codes. By virtue of the provision of execution codes in the memory of the control unit, the distributor unit can be operated independently of other units in the electric bicycle. The distributor unit can comprise more than one power-transmitting interface.

The distributor unit can be power-connected to a battery of the bicycle by way of a power-transmitting interface. For example, the power-transmitting interface can have a plug point in the distributor unit into which a plug with a cable from the battery can be inserted. The battery can be fitted into or onto a bicycle frame of the bicycle and the battery can be designed to supply a drive unit of the bicycle with electrical energy. The distributor unit can be connected to a consumer by way of the power-transmitting interface. Alternatively, or in addition, the distributor unit can be connected to a consumer by way of a further power-transmitting interface of the distributor unit. The distributor unit can be power-connected to more than one consumer. The consumer can be at least one among the front light, rear light, gearshift mechanism, and an acoustic signal emitter. The acoustic signal emitter can be, for example, an electric bell, a horn, or a signaling hooter. The power connection can be an electrical connection. In other words, an electrical connection can exist from the battery, via the distributor unit to the consumer.

The control unit is designed to control the supply of electrical energy to the consumer from the battery in accordance with a control signal. The control unit can be designed to determine the control signal. The control unit can be designed to supply electrical energy from the battery to the consumer in accordance with the control signal, and for this can have, for example, transformer that can be controlled by the control signal. Alternatively, or in addition, the control unit can be designed to send the control signal to the consumer. In that case the consumer can be designed to call for electrical energy from the battery automatically in accordance with the control signal. The control of the supply to the consumer can entail switching the consumer on or off and throttling or increasing the energy supply to the consumer.

Thus, advantageously, a distributor unit for an electric bicycle is provided, with which one or more consumers can be supplied with electrical energy from the battery by way of the distributor unit. A single voltaic connection, also called a power connection, between the battery and the distributor unit can in this way connect a plurality of consumers to the battery and thus supply them with electrical energy from the battery. Thanks to the arrangement of the distributor unit in the upper tube, the distributor unit can be easily accessed, particularly for maintenance or repair purposes. Thus, a power connection between a distributor unit and a consumer can be exchanged without having to access the power connection between the distributor unit and the battery. This can be particularly advantageous when the connection between the distributor unit and the battery is arranged inside the bicycle frame and can therefore only be accessed with difficulty. Furthermore, in this way there is no need for a plurality of cables between the consumers and the battery, and this saves space within the bicycle frame. That space can be used, for example, to accommodate the battery.

In a further embodiment the control unit can be designed to read in acceleration data. The acceleration data can include acceleration data pertaining to the bicycle, in particular acceleration data of the distributor unit. The acceleration data can be captured by means of an acceleration sensor. The acceleration sensor can be arranged in the distributor unit. Alternatively, or in addition, the acceleration sensor or a further acceleration sensor can be arranged on the bicycle outside the distributor unit, for example on a bicycle component such as a front spring fork or a rear wheel fork, on the handlebar, or on the drive unit. The acceleration data can include information about a linear acceleration and alternatively or in addition about a rotational acceleration of the distributor unit or the bicycle. The control unit can be designed to control a consumer as a function of the acceleration data in accordance with a control signal. For that purpose, the control unit can be designed to determine the control signal as a function of the acceleration data. For example, the control unit can be designed to control a rear light as the consumer, as a function of the acceleration data. Thus, during a sharp deceleration produced when the user of the bicycle brakes, the rear light can be controlled by the control unit on the basis of the acceleration data in such manner that the rear light flashes or lights up red. Furthermore, the control unit can be designed to recognize an undesired acceleration, for example during an attempted theft or during a fall.

The control unit can then be designed to activate a consumer in reaction to that. Thus, in an attempted theft all the lights and acoustic signals as well can be switched on, while in the event of a fall the control unit can be designed to emit an emergency signal by way of a radio interface. Moreover, the acceleration sensor can contain information about the topography of the surroundings such as information about the gradient of the surroundings. The control unit can be designed to control the drive unit, as consumer, as a function of the gradient. Thus, perhaps a supportive power provided by the drive unit can be increased on a steeper slope. Advantageously, the distributor unit can be designed to react to a relative movement change in an environment and to control a consumer as a function of that.

In a further embodiment, the distributor unit can comprise a charging interface for a mobile terminal device. The charging interface can comprise a plug-in connection. Alternatively, or in addition, it can comprise an inductive connection interface. Alternatively, or in addition, the mobile terminal device can comprise a frictional connection with the charging interface, which is frictional and detachable. For example, this can be by means of magnets in the charging interface and, alternatively or in addition, in the mobile terminal device. One out of the charging interface and the mobile terminal device can be made for the frictional connection from only one magnetizable material, such as iron. This can then be attracted by a magnet in the corresponding component. The mobile terminal device can be, for example, a Smartphone belonging to the user. The distributor unit can be designed to charge the mobile terminal device with electrical energy from the battery via the charging interface. Alternatively, or in addition, the distributor unit can be designed to charge the battery with electrical energy from the mobile terminal device via the charging interface. Thus, electrical energy can advantageously also be distributed between the user's mobile terminal device and the bicycle by way of the distributor unit.

In a further embodiment, the distributor unit can comprise a data interface for a mobile terminal device. The data interface, together with the charging interface, can be in the form of one interface such as a USB socket. Alternatively, or in addition, the data interface can comprise a radio interface. The distributor unit can be designed to receive data via the data interface from the mobile terminal device. Alternatively, or in addition, the distributor unit can be designed to send data via the data interface to the mobile terminal device. The control unit can be designed to read in the data received from the mobile terminal device. Data received from the mobile terminal device can include, for example, information about what the user wants. Such information can, for example, be input by the user via an application in the mobile terminal device. The control unit can be designed to control a consumer as a function of the data read in, in accordance with a control signal.

For example, the control unit can be designed, by way of the data interface, to transmit a charging status of the battery of the bicycle to the mobile terminal device. The mobile terminal device can show the user the charging status on a display of the mobile terminal device. In reaction to this the user can indicate a priority of consumers to be supplied. This information can be received by the distributor unit via the data interface and read in by the control unit. Then the control unit can be designed to determine a control signal such that, for example, the front light is primarily supplied with electrical energy whereas owing to the low charging status of the battery and the user's input other consumers are not supplied with energy. By virtue of such a user-defined prioritization of consumers to be supplied, the driving experience of the user can be influenced and improved directly. Moreover, the control unit can be designed, in the event of a fall recognized on the basis of acceleration data received, to send a signal to the mobile terminal device, so that the mobile terminal device can be used as a radio interface for emitting an emergency signal. Furthermore, the control device can be designed, by way of such a radio interface in the form of the mobile terminal device, to transmit data from the mobile terminal device to a Cloud. For example, that can take place in a time-triggered or event-triggered manner such as in the event of a breakdown Data transmitted to the Cloud can be used as fleet data for the data analysis of systematic defects in distributor units or bicycles. Furthermore, the control unit can be designed to receive software updates via the data interface. The control unit can then be designed to control consumers as a function of the software updates. For example, after the software update a consumer such as the drive unit can be controlled otherwise than before the software update.

In a further embodiment the distributor unit can comprise a user interface. The user interface can comprise input means and, alternatively or in addition, output means. For example, the user interface can comprise a touch-screen display, a loudspeaker, keys, and alternatively or in addition, knobs. A distributor unit with such a user interface can be a Core-HMI, Core Human Machine Interface. The user interface can be designed to register a user's input. For example, the previously discussed prioritization can take place directly at the distributor unit by means of user inputs via the user interface. The control unit can be designed to read in the user's input registered and to control a consumer in accordance with a control signal as a function of the user's input. For example, by way of the user interface the user can switch the front light and the rear light, as consumers, on and off. By way of the user interface the supply of all the consumers and the supply of the drive unit with electrical energy from the battery can be switched on and off. Moreover, via the user interface the supporting power, also known as the support level, can be adjusted by the user. In addition, by means of input means such as keys, if the user actuates a key combination a Bluetooth Pairing with a mobile terminal device can be created. A data connection between the distributor unit and a mobile terminal device can for example be made in that way. Furthermore, the user interface can comprise output means such as acoustic and alternatively or in addition visual output means. Acoustic output means can consist of a loudspeaker or a horn. Visual output means can include a display such as the touch-screen display and, alternatively or in addition, LEDs. The control unit can be designed, by way of the output means, to communicate to the user the charging status of the battery, defect codes of various consumers and, alternatively or in addition, defect codes of the distributor unit itself.

According to a further embodiment, the distributor unit can comprise a data interface which can be designed to communicate with some other component of the electric bicycle. The data interface can be formed together with the power-transmitting interface of the distributor unit. The distributor unit can have more then one data interface for communicating with more than one component. The further component, for example, can be the drive unit, the battery or one or more consumers. The control unit can be designed to read in data from the further components of the electric bicycle via the data interface. The control unit can interrogate the further components actively for these data. Alternatively, or in addition, the components can send the data actively to the control unit, for example as triggered by time or events. In particular, if new data values are present in the components the sending of data to the control unit by the components is triggered. The control unit can be designed to control a consumer in accordance with a control signal as a function of the data. For example, the charging status sensor can send information about the charging status of the battery to the distributor unit. The control unit can then be designed to determine a control signal on the basis of data received about the charging status, and thus to control consumers in such manner that the supply of all the consumers to be supplied from the distributor unit is enabled having regard to the current charging status of the battery.

A further aspect of the invention relates to a bicycle with a distributor unit according to an embodiment of the preceding aspect of the invention. The bicycle can be, for example, a Pedelec, an electric mountain bike, or an electric cargo bike.

According to a further embodiment, the bicycle can comprise a bicycle frame with an upper tube, a battery, a drive unit, and a consumer. Besides the upper tube, the bicycle frame can comprise a seat column and a lower tube. The battery can be arranged in the bicycle frame, in the seat column and alternatively or in addition in the lower tube of the bicycle frame. The drive unit can be arranged on a cross-piece between the seat column and the lower tube. The bicycle can have more than one consumer. For example, the bicycle can have as consumers a front light, a rear light, a bell, and gearshifts. The distributor unit can be arranged in the upper tube. In particular the distributor unit can be arranged forward in the driving direction on the upper tube and close to the junction between the upper tube and the lower tube. The distributor unit can be arranged in the upper tube in such manner that a user interface of the distributor unit faces upward and toward a user sitting on the bicycle.

The consumer can be connected indirectly to the battery via the distributor unit. In other words, the consumer can be connected directly to the distributor unit and the distributor unit directly to the battery. The drive unit can be connected directly to the battery. Starting from the lowest part of the frame, the drive unit can be positioned at a junction between the seat column and the lower tube. The battery can be arranged directly connected thereto and farther up in the lower tube. The distributor unit can be arranged connected directly thereto and farther up in the bicycle frame, more precisely in the upper tube. Connected directly to the distributor unit and, for example, fitted onto on the handlebar, the front light can be arranged as a consumer.

In a further embodiment, a first cable can lead from the consumer to the distributor unit. Alternatively, a plurality of first cables from several consumers can lead to the distributor unit. For example, a first cable can lead from the acoustic signal emitter, i.e., the electric bell, hooter, or horn, to the distributor unit and a further first cable can lead from the front light to the distributor unit. These first cables from the consumers to the distributor unit can be made relatively short, particularly when the consumers are arranged on the handlebar, and are therefore easily accessible for maintenance and repair work.

A second cable lead from the distributor unit to the battery. In particular the second cable can have a thicker cross-section than any of the first cables in order to make it possible to carry all the electrical energy provided for the consumers connected to the distributor unit in the second cable. The second cable can run completely inside the bicycle frame and be built into the frame. A third cable can lead from the battery to the drive unit. The third cable can be arranged completely in and built into the bicycle frame, in particular completely in the bottom part of the lower tube. The first, second, and third cables can be power cables and at the same time data carrying cables.

Advantageously, therefore, a bicycle can be produced in which an exchange or addition of consumers can take place particularly easily, since a first cable can easily be exchanged or added, and especially because no cable leading directly from the consumer to the drive unit has to be exchanged or added.

According to a further embodiment, the drive unit comprises a drive motor. The motor control unit can be designed to control the drive motor. In particular the motor control unit can be designed to control only the drive motor. In particular, the third cable can be only a power cable and not a data cable, so that consumers cannot be controlled by way of the motor control unit.

Thus, advantageously, a bicycle can be obtained in which consumers can be controlled independently of the motor control unit by way of the distributor unit.

### BRIEF DESCRIPTION OF THE FIGURES

FIG. 1a: shows a distributor unit according to an embodiment, seen as a perspective view from above.

FIG. 1b: shows a distributor unit according to an embodiment, seen as a perspective view from below.

FIG. 2: shows a schematic illustration of an embodiment of a distributor unit with further components connected thereto.

FIG. 3: shows an electric bicycle with a distributor unit in the upper tube, in accordance with an embodiment.

### DETAILED DESCRIPTION OF EMBODIMENTS

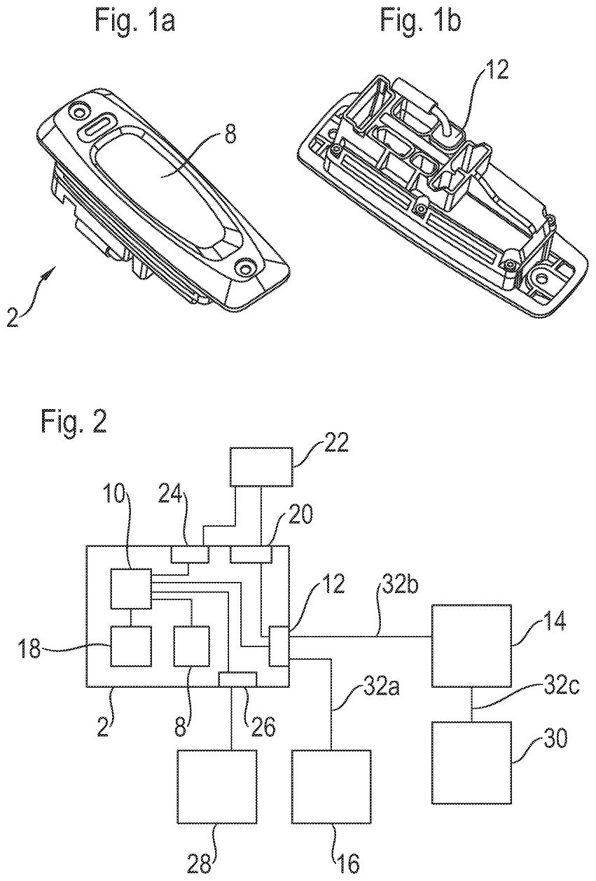

FIGS. 1a and 1b show a distributor unit 2 according to an embodiment, viewed in perspective. The distributor unit 2 is designed to be arranged in an upper tube 6 of an electric bicycle 4, shown in FIG. 3. The electric bicycle 4 comprises a bicycle frame 7 with the upper tube 6. The electric bicycle 4 has a drive unit 30, which is arranged at a junction of a seat column and a lower tube of the bicycle frame 7. The electric bicycle 4 has a battery 14, which is arranged in the lower tube of the bicycle frame 7. The battery 14 and the drive unit 30 are connected by a third cable 32c. The battery 14 and the distributor unit 2 are connected by a second cable 32b. The second and third cables 32b. 32c are fitted into the lower tube of the bicycle frame 7 and are not easy to access. The distributor unit 2 is located close to a junction between the lower tube and the upper tube 6 of the bicycle frame 7. The electric bicycle 4 has a front light as a consumer 16. The consumer 16 is connected directly to the distributor unit 2 by a first cable 32a. The first cable 32a is easily accessible; for example, it suffices to dismantle the distributor unit 2 to disconnect the first cable 32a from the distributor unit 2 and take it off the bicycle 4.

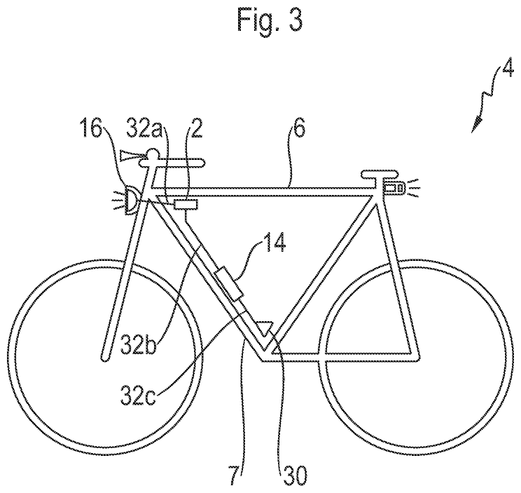

The distributor unit 2 has a user interface 8, which is shown in FIG. 1a. The user interface 8 is a touch-screen display and the touch-screen display is arranged on the upper tube 6 in such manner that a user sitting on the bicycle 4 can access the user interface 8 directly. As an example, FIG. 1b shows a power-transmitting interface 12 of the distributor unit 2. As shown in FIG. 2, by way of the power-transmitting interface 12 the distributor unit 2 is connected directly to the battery 14 and the consumer 16. The distributor unit 2 has a control unit 10, as shown schematically in FIG. 2. The control unit 10 is designed to control the supply of electrical energy to the consumer 16 from the battery 14. For that purpose, the control unit 10 is designed to determine a control signal and to control the supply by virtue of the control signal.

The distributor unit 2 also comprises an acceleration sensor 18. The acceleration sensor 18 and the control unit 10 are connected, so that the control unit 10 can read in data detected by the acceleration sensor 18. In this case the control unit 10 is designed to determine a control signal for controlling the consumer 16 as a function of the acceleration data.

Furthermore, the distributor unit 2 comprises a charging interface 20. The charging interface 20 is in the form of an inductive charging interface and is designed to charge a mobile terminal device 22 with electrical energy from the battery 14. The charging interface 20 is arranged in the distributor unit 2 in such manner that a mobile terminal device 22 close to the user interface 8, shown in FIG. 1a, can be charged. For that purpose, the distributor unit 2 and in particular the control unit 10 are designed to control the charging of the mobile terminal device 22.

In addition, the distributor unit 2 comprises a data interface 24. The data interface 24 is in the form of a radio interface and is designed to operate data communication with the mobile terminal device 2. The control unit 10 is designed to receive and read in data from the mobile terminal device 22 via the data interface 24 and to control the consumer 16 as a function of that data in accordance with a control signal to be determined. Thus, for a user it is possible to input the user's wish by way of the mobile terminal device, so that for example the front light, as a consumer 16, is switched on or off.

Alternatively, or in addition, the user's input for switching the front light on or off as the consumer 16 takes place by way of the user interface 8. In that case, the control unit 10 is designed to determine the control signal for controlling the consumer 16 as a function of the user's input via the user interface 8.

Furthermore, the distributor unit 2 comprises a data interface 26. A further component 28 of the electric bicycle 4 includes for example a charging status sensor for determining the charging status of the battery 14. The control unit 10 is designed to control the front light as a consumer 16 as a function of the charging status data received from the component 28 with reference to the charging status of the battery 14. For example, the control unit 10 is designed to dim the front light as a consumer 16 and thereby to limit the electrical energy consumption of the consumer 16 if the charging status of the battery 14 is low.

It can be seen from both FIG. 2 and FIG. 3 that there is a continuous electrical connection from the drive unit 30 via the battery 14 and further through the distributor unit 2 to the consumer 16. A direct electrical connection, for example by way of a separate cable from the consumer 16 to the drive unit 30, is thus not necessary. An exchange or maintenance of the first cable 32a and the consumer 16 is thereby facilitated since the accessibility of the consumer 16 and the first cable 32a is better than the accessibility of the cables 32b and 32c.

### INDEXES

2 Distributor unit
4 Electric bicycle
6 Upper tube
7 Bicycle frame
8 User interface
10 Control unit
12 Power-transmitting interface
14 Battery
16 Consumer
18 Acceleration sensor
20 Charging interface
22 Mobile terminal device
24 Data interface
26 Data interface
28 Further component of the electric bicycle
30 Drive unit
32a First cable
32b Second cable
32c Third cable

1. A distributor unit (2) for an electric bicycle (4) having a battery, the distributor unit comprising:
a control unit (10); and
a power-transmitting interface (12);
wherein the distributor unit (2) is configured be power-connected via the power-transmitting interface (12) to the battery (14) of the electric bicycle (4);
wherein the distributor unit (2) is configured to be power-connected via the power-transmitting interface (12) to a consumer (16);
wherein the control unit (10) is configured to control the supply to the consumer (16) of electrical energy from the battery (14) by way of the distributor unit (2) in accordance with a control signal; and
wherein the distributor unit (2) is configured to be arranged in an upper tube (6) of the bicycle (4).

2. The distributor unit (2) according to claim 1, further comprising an acceleration sensor (18), wherein the control unit (10) is configured to read in acceleration data detected by the acceleration sensor (18), and wherein the control unit (10) is configured to control a consumer (16) as a function of the acceleration data in accordance with a control signal.

3. The distributor unit (2) according to, comprising:
a charging interface (20) for a mobile terminal device (22), wherein the distributor unit (2) is configured to charge the mobile terminal device (22) with electrical energy from the battery (14) by way of the charging interface (20).

4. The distributor unit (2) according to claim 1, comprising:
a data interface (24) for a mobile terminal device (22);
wherein the distributor unit (2) is configured to receive data from the mobile terminal device (22) by way of the data interface (24); and
wherein the control unit (10) is configured to read in the data received from the mobile terminal device (22) and to control a consumer (16) as a function of the data read in and in accordance with a control signal.

5. The distributor unit (2) according to claim 1, comprising:
a user interface (8), and the user interface (8) is configured to receive a user's input and the control unit (10) is configured to read in the user's input detected and to control a consumer (16) as a function of the user's input read in and in accordance with a control signal.

6. The distributor unit (2) according to claim 1, comprising:
a data interface (26) configured for communication with a further component (28) of the electric bicycle (4);
wherein the control unit (10) is configured to read in data from the said further component (28) of the electric bicycle (4) via the data interface (26); and
wherein the control unit (10) is designed to read in the data from the further component (28) of the electric bicycle (4) and to control a consumer (16) as a function of the said data and in accordance with a control signal.

7. A bicycle having a distributor unit (2) according to claim 1.

8. The bicycle (4) according to claim 7, the bicycle comprising a bicycle frame (7) with an upper tube (6), a battery (14), a drive unit (30), and a consumer (16), wherein the distributor unit (2) is arranged in the upper tube (6), wherein the battery (14) is arranged in the bicycle frame (7), and wherein the consumer (16) is connected indirectly to the battery (14) by way of the distributor unit (2) and the drive unit (30) is connected directly to the battery (1).

9. The bicycle (4) according to claim 8, comprising:
a first cable (32a) connecting the consumer (16) to the distributor unit (2);
a second cable (32b) connecting the distributor unit to the battery (14); and
a third cable (32c) connecting the battery (14) to the drive unit (30).

10. The bicycle (4) according to claim 8, wherein the drive unit (30) comprises a drive motor and a motor control unit, and wherein the motor control unit is configured to control the drive motor (28).

11. The bicycle (4) according to claim 9, wherein the drive unit (30) comprises a drive motor and a motor control unit, and wherein the motor control unit is configured to control the drive motor (28).
